(19) United States
(12) Patent Application Publication
(10) Pub. No.: US 2012/0042369 A1
(43) Pub. Date: Feb. 16, 2012

(54) Data Card, Method and System for Identifying Fingerprint with Data Card

(75) Inventor: Rui Fan, Xian (CN)

(73) Assignee: Huawei Device Co., LTD, Shenzhen (CN)

(21) Appl. No.: 13/283,035

(22) Filed: Oct. 27, 2011

Related U.S. Application Data
(63) Continuation of application No. PCT/CN2010/073785, filed on Jun. 11, 2010.

(30) Foreign Application Priority Data
Oct. 16, 2009 (CN) 200910110532.X
Nov. 16, 2009 (CN) 200910109728.7

(51) Int. Cl. H04L 9/32; G06F 21/20

(52) U.S. Cl. 726/7; 726/19

(57) ABSTRACT

A data card, and a method and system for identifying a fingerprint with data card in the field of electronic communications are provided. The data card includes a fingerprint collection module that is configured to collect user's fingerprint information by using a fingerprint scanner on the data card. A fingerprint authentication module is configured to compare the collected fingerprint information with a stored fingerprint template and output a comparison result. A control module is configured to control the data card according to the comparison result output by the fingerprint authentication module.

This application is a continuation of International Application No. PCT/CN2010/073785, filed on 11 Jun., 2010, which claims priority to Chinese Patent Application No. 200910110532.X, filed on Oct. 16, 2009, and to Chinese Patent Application No. 200910109728.7, filed on Nov. 16, 2009, all of which are hereby incorporated by reference in their entireties.

### TECHNICAL FIELD

The present invention relates to the field of communications technologies, and particularly to a data card, and a method and a system for identifying fingerprint with a data card.

### BACKGROUND

A data card, also known as a wireless network card, a broadband network card, or a USB modem, is Internet access equipment for accessing a wireless network. The data card can access the wireless network through mobile communication technologies such as the Global System for Mobile communications (GSM), the Universal Mobile Telecommunication System (UMTS) or the Code Division Multiple Access (CDMA), so as to realize functions such as voice, short messages, and data services. The main function of the data card is to connect to the Internet through dial-up for data services (commonly known as accessing the Internet).

With the rapid development of the mobile communication technology, data services such as wireless Internet access are gradually becoming mature, and portable and small-size wireless Internet access terminals such as a wireless data card are becoming increasingly popular. The wireless data card does not need a power charger, and can be supplied by directly plugging into a universal serial bus (USB) port of a notebook computer or a desktop computer. With just one Subscriber Identity Module (SIM) card, a user can have data services such as wireless Internet access without a network cable, so as to enjoy the Internet anytime and anywhere.

The current wireless data card has security deficiencies. An SIM card has a few simple protective measures, namely, the user can set a simple combination of numbers from 0 to 9 as a personal identification number (PIN) code, and the SIM card can only be used after the PIN code is input. In this mode, the password is simple, and the user only needs to input numbers to access Internet by using the data card.

In the implementation of the present invention, the inventor finds that the prior art has the following problems. The requirements for setting the PIN code of the SIM card confined to numbers are simple, so that the PIN code can be easily cracked, resulting in low security.

### SUMMARY OF THE INVENTION

An embodiment of the present invention, according to an aspect, provides a fingerprint identification data card, and according to another aspect, provides a method for identifying fingerprint with data card, improving the security of the use of the data card, and effectively ensuring that the data card is not misappropriated.

An embodiment of the present invention provides a data card, which includes a fingerprint collection module that is configured to collect user's fingerprint information by using a fingerprint scanner on the data card. A fingerprint authentication module is configured to compare the collected fingerprint information with a stored fingerprint template, and to output a comparison result. A control module is configured to control the data card according to the comparison result output by the fingerprint authentication module.

An embodiment of the present invention further provides wireless Internet access equipment, which includes a registration module that is configured to register the wireless Internet access equipment with the wireless network. A fingerprint identification module is configured to obtain fingerprint information input by the user by using a fingerprint sensor, and to match the input fingerprint information with a stored fingerprint template after the registration module finishes registration. A processing module is configured to perform a dial-up connection and to establish a data service connection between the wireless Internet access equipment and the wireless network when the input fingerprint information successfully matches with the stored fingerprint template in the fingerprint identification module.

An embodiment of the present invention further provides a method for identifying fingerprint with data card. A user's fingerprint information is collected by using a fingerprint scanner of the data card. The collected fingerprint information is compared with a stored fingerprint template and a comparison result is output. Corresponding control on the data card is performed according to the output comparison result.

Furthermore, an embodiment of the present invention further provides a dial-up method for accessing wireless Internet. Wireless Internet access equipment is registered with a wireless network. A fingerprint sensor is used to obtain fingerprint information input by the user. The input fingerprint information is matched with a stored fingerprint template. If the input fingerprint information successfully matches with the stored fingerprint template, the wireless Internet access equipment performs a dial-up connection, and a data service connection is established with the wireless network.

It can be known from the preceding technical solutions that, the user's fingerprint information is collected by using the fingerprint scanner on the data card and compared with the stored fingerprint template, the comparison result is output, and then the data card is controlled according to the output comparison result. Therefore, the use of the data card is controlled through the fingerprint authentication, and the data card can only be used after successful fingerprint matching. As the security of fingerprint authentication is much higher than the security of password authentication, the security of the data card is improved, and it is effectively ensured that the data card is not misappropriated.

### BRIEF DESCRIPTION OF THE DRAWINGS

To make the technical solution under the present invention clearer, the accompanying drawings for illustrating the embodiments of the present invention or the prior art are outlined below. Apparently, the accompanying drawings are for the exemplary purpose only, and person having ordinary skill in the art can derive other drawings from such accompanying drawings without any creative effort.

FIG. 1 is a flow chart of a method for identifying fingerprint with a data card according to an embodiment of the present invention;

FIG. 2 is a flow chart of a dial-up method for accessing wireless Internet according to an embodiment of the present invention;

FIG. 3 is a flow chart of a dial-up method for accessing wireless Internet according to another embodiment of the present invention;

FIG. 4 is a flow chart of a dial-up method for accessing wireless Internet according to another embodiment of the present invention;

FIG. 5 is a schematic structural view of a data card according to an embodiment of the present invention;

FIG. 6 is a schematic structural view of dial-up equipment for accessing wireless Internet according to an embodiment of the present invention;

FIG. 7 is a schematic structural view of another dial-up equipment for accessing wireless Internet according to an embodiment of the present invention; and

FIG. 8 is a schematic view of a dial-up system for accessing wireless Internet according to an embodiment of the present invention.

### DETAILED DESCRIPTION OF ILLUSTRATIVE EMBODIMENTS

The technical solution under the present invention is elaborated below with reference to accompanying drawings. Evidently, the embodiments described below are for the exemplary purpose only, without covering all embodiments of the present invention. Those skilled in the art can derive other embodiments from the embodiments given herein without making any creative effort, and all such embodiments are covered in the protection scope of the present invention.

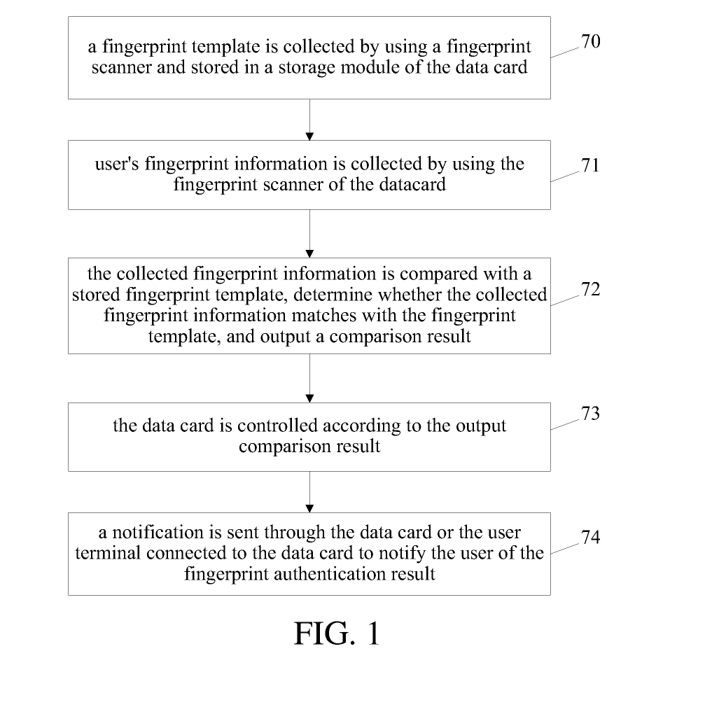

As shown in FIG. 1, an embodiment of the present invention provides a method for identifying fingerprint with a data card, which includes the following steps.

Step 71: User's fingerprint information is collected by using a fingerprint scanner of the data card.

Step 72: The collected fingerprint information is compared with a stored fingerprint template, so as to determine whether the collected fingerprint information matches with the fingerprint template, and then a comparison result is output.

Step 73: The data card is controlled according to the output comparison result.

The data card establishes a wireless connection with the Internet through a radio frequency (RF) module to receive and transmit data. The data card is connected to a user terminal through various interfaces (such as a universal serial bus, USB interface), so that the user terminal can perform data transmission with the Internet through the data card.

The corresponding control in step 73 may include a number of steps. The user is authenticated through fingerprint authentication. If the collected fingerprint information matches with the fingerprint template, it is determined that the authentication is successful, and the user corresponding to the collected fingerprint information is allowed to access the Internet by using the data card. Otherwise, if the collected fingerprint information does not match with the fingerprint template, it is determined that the authentication is failed, and the user is not allowed to use the data card. And/or, one or more different fingerprint templates are stored, and each fingerprint template corresponds to different operations. If the collected fingerprint information matches with any one of the fingerprint templates, the operation corresponding to the matched fingerprint template is performed. If the collected fingerprint information matches with none of the fingerprint templates, the data card performs no operation or notifies the user that the fingerprint authentication is failed through the data card or the user terminal connected to the data card. As for the implementation that the user corresponding to the collected fingerprint information is allowed to access the Internet by using the data card, and the implementation of the operations corresponding to the matched fingerprint templates, the related content in the device embodiment can be referred to, which will not be described here again.

It should be noted that, for a multi-mode data card, the user can choose different Internet services by registering different fingerprint templates. For example, for a data card that supports both the Global System for Mobile Communications (GSM) and the Wideband Code Division Multiple Access (WCDMA), the user registers the left index finger to initiate the GSM network, and registers with the right index finger to initiate the WCDMA network. After inserting the data card, the user swipes the left index finger to initiate the RF module of the GSM, and at this time, the GSM network can be searched and registered. Similarly, the user swipes the right index finger to initiate the RF module of the WCDMA to use the WCDMA network.

In addition, after step 73, the above method may further include step 74. A notification is sent through the data card or the user terminal connected to the data card to notify the user of the fingerprint authentication result. Here, the user's fingerprint authentication result may be: the fingerprint authentication is successful; the fingerprint authentication is successful, and the data card has established a connection with the Internet; the fingerprint authentication is successful, and the data card has established a connection with the Internet through one of the multiple RF modules; the fingerprint authentication is failed, and the user cannot use the data card; the fingerprint authentication is failed, and the user is required to input the fingerprint information again.

In addition, before step 71, the above method may further include step 70. When the data card is set, a fingerprint template is collected by using the fingerprint scanner and stored in a storage module of the data card. The storage module may be a memory or a non-volatile memory such as a Flash. For example, when the user initiates the data card for the first time, the data card prompts the user to input each fingerprint template, and the fingerprint information input by using the fingerprint scanner is stored in the storage module as a fingerprint template. Alternatively, during the use of the data card, the original fingerprint template is updated and replaced, and the fingerprint information input by using the fingerprint scanner at this time is stored in the storage module to replace the original fingerprint template. Before the update and replacement, it can be set that the user needs to input the correct fingerprint information and the update and replacement is only allowed after the authentication of the fingerprint authentication is successful.

It should be noted that, if the data card has only one RF module, when the data card is powered on, the RF module immediately starts to search and register with the network, and the user is not allowed to use the data card. Next, after the fingerprint authentication is successful (that is, the collected fingerprint information matches with the fingerprint template), the user is allowed to use the data card to perform data transmission through the wireless network connected by the RF module. Alternatively, when the data card is powered on, the user is not allowed to use the data card and the RF module is in an “off” state. Next, after the fingerprint authentication is successful, the RF module starts to search and register with the network and the user is allowed to use the data card. In the end, the user can perform data transmission through the wireless network connected by the RF module.

In this embodiment, the user's fingerprint information is collected by using the fingerprint scanner on the data card and compared with the stored fingerprint template, and then the data card is controlled according to the comparison result output by the fingerprint authentication module. Thus, the authentication of the data card is realized through the fingerprint authentication, and related functions of the data card can only be used after successful fingerprint matching. As the security of the fingerprint authentication is much higher than the security of password authentication, the security of the data card is improved, and it is effectively ensured that the data card is not misappropriated. In addition, the fingerprint authentication is performed for the data card, so even if the user changed an SIM card, the data card still cannot be used as long as the fingerprint authentication is failed, so that the security of the data card is further improved. Moreover, the user does not need to remember a password during fingerprint authentication, and a network connection is automatically established upon successful fingerprint authentication, so that it becomes more convenient for the user and the complexity of the operations is reduced.

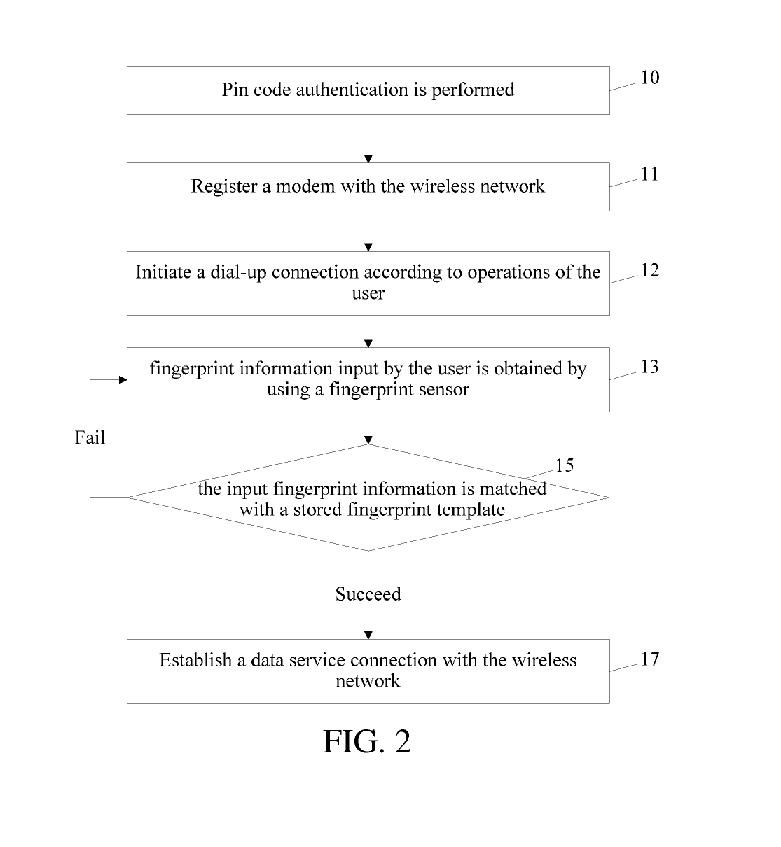

FIG. 2 illustrates a dial-up method of wireless Internet access equipment (such as a wireless network card) according to an embodiment of the present invention. The embodiment of the present invention provides a dial-up method for accessing wireless Internet, which includes the following steps.

Step 11: The wireless Internet access equipment is registered with the wireless network.

In step 11, after being powered up, the wireless Internet access equipment can register itself with the wireless network by using the existing technologies. The wireless network here may be 2G or Third Generation (3G) wireless networks such as GSM, CDMA, and UMTS. The wireless Internet access equipment is electrically connected to a PC.

Step 13: Fingerprint information input by the user is obtained by using a fingerprint sensor.

The fingerprint sensor may be integrated in the wireless Internet access equipment, or disposed on the PC, or disposed in other equipment (such as a separated USB fingerprint sensor) and connected to the PC through various interfaces. After obtaining the fingerprint information input by the user, the fingerprint sensor sends the fingerprint information to a related module or equipment to be matched.

Step 15: The input fingerprint information is matched with a stored fingerprint template. If the input fingerprint information successfully matches with the stored fingerprint template, step 17 is performed. If the input fingerprint information does not match with the stored fingerprint template, returns to step 13, when the user inputs fingerprint information next time, the fingerprint information input by the user is obtained by the fingerprint sensor.

In this step, the wireless Internet access equipment or the PC can match the fingerprint information with the fingerprint template. For example, when the fingerprint template is stored in the wireless Internet access equipment, the wireless Internet access equipment receives the fingerprint information sent by the fingerprint sensor. Next, the fingerprint information is matched with the stored fingerprint template, and a matching result is sent to the PC for subsequent processes or subsequent processes are directly performed according to the matching result. Alternatively, when the fingerprint template is stored in the wireless Internet access equipment, the PC receives the fingerprint information sent by the fingerprint sensor and reads the fingerprint template from the wireless Internet access equipment.

Next, the PC matches the received fingerprint information with the read fingerprint template, and subsequent processes are performed according to the matching result or the matching result is sent to the wireless Internet access equipment for subsequent processes. Alternatively, when the fingerprint template is stored in the PC, the wireless Internet access equipment receives the fingerprint information sent by the fingerprint sensor and reads the fingerprint template from the PC.

Next, the wireless Internet access equipment matches the received fingerprint information with the read fingerprint template, and the matching result is sent to the PC for subsequent processes or subsequent processes are performed according to the matching result. Alternatively, when the fingerprint template is stored in the PC, the PC receives the fingerprint information sent by the fingerprint sensor and reads the fingerprint template from the wireless Internet access equipment. Next, the PC matches the received fingerprint information with the stored fingerprint template, and subsequent processes are performed according to the matching result, or the matching result is sent to the wireless Internet access equipment for subsequent processes.

Step 17: The wireless Internet access equipment performs a dial-up connection and establishes a data service connection with the wireless network.

After establishing the data service connection, the wireless Internet access equipment may perform data service interaction with the wireless network, that is, the PC may access the Internet by using the wireless Internet access equipment.

Optionally, if the wireless Internet access equipment is a data card, referring to FIG. 2, before step 11, the dial-up method of the wireless Internet access equipment may further include step 10. After the data card is powered up, PIN code authentication is performed. If the PIN code authentication is successful, step 11 is performed. Otherwise, if the PIN code authentication is failed, all the SIM-related functions (including the dial-up connection function) of the data card cannot be used, and the above process is terminated or it is notified that the PIN code authentication is failed so that the user inputs the PIN code again.

Optionally, referring to FIG. 2, after step 11, the method may further include step 12: A dial-up connection is initiated according to operations of the user, and the user is prompted to input fingerprint information. In the actual operations, the process of the dial-up connection includes two steps. First, a dial-up command is delivered to the wireless Internet access equipment. Second, the wireless Internet access equipment establishes a data service connection with the wireless network according to the dial-up command and dial-up connection settings. Here, the initiation of the dial-up connection in step 12 may be that the PC delivers a dial-up command to the wireless Internet access equipment. Specifically, the delivery of the dial-up command may be that background software installed in the PC sends the dial-up command to the wireless Internet access equipment through the connection to the wireless Internet access equipment. For example, the background software sends the dial-up command to the wireless Internet access equipment by invoking an Application Programming Interface (API) of a dial-up connector of Windows. The prompting the user to input fingerprint information is optional and may be implemented in various modes, such as popping-up a prompt dialog box in the system of the PC, which is not limited here. The prompting the user to input fingerprint information in other steps is similar to step 12, which will not be described again.

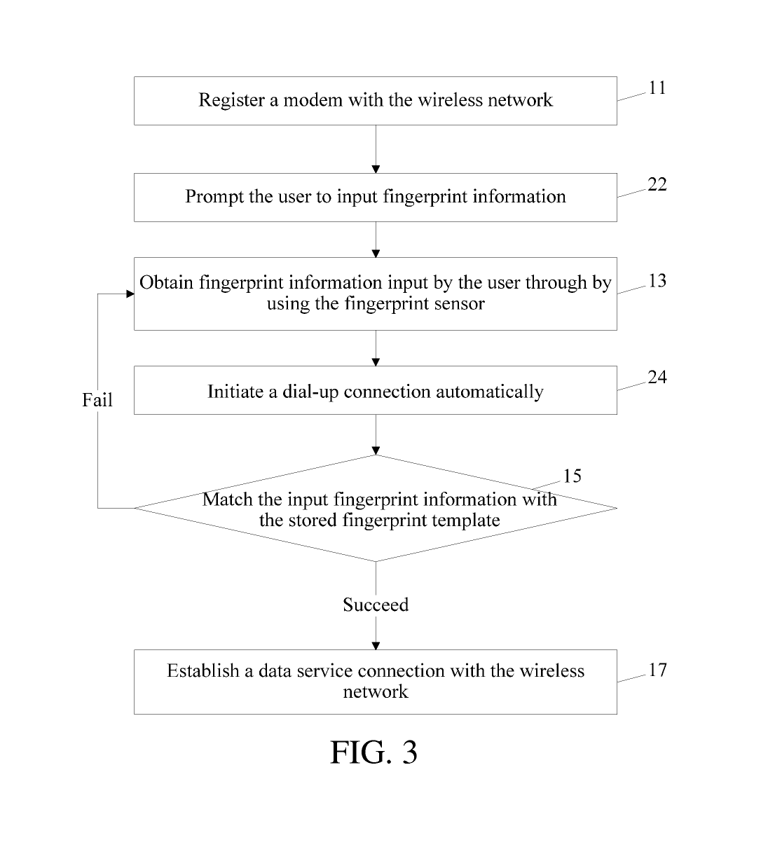

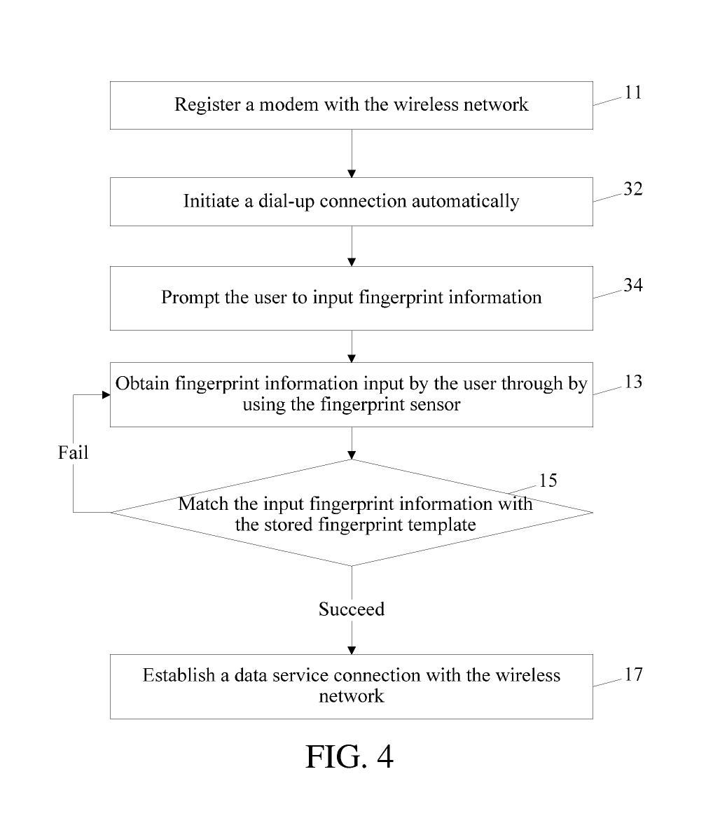

In addition, as step 12 is optional, step 12 may be omitted in other embodiments. For example, referring to FIG. 3, after step 11 is performed, step 22 is performed to prompt the user to input fingerprint information, or no operation is performed and the user is waited to input fingerprint information. When the fingerprint information input by the user is obtained by using the fingerprint sensor in step 13, step 24 is performed. In step 24, the PC automatically initiates a dial-up connection and delivers the dial-up command to the wireless Internet access equipment. Alternatively, referring to FIG. 4, after step 11 is performed, step 32 is performed. In step 32, the PC automatically initiates a dial-up connection and delivers the dial-up command to the wireless Internet access equipment. When or after the dial-up command is delivered, step 34 may be performed to prompt the user to input fingerprint information, or no operation is performed and the user is waited to input the fingerprint information.

In step 17, the performing the dial-up connection and establishing the data service connection with the wireless network by the wireless Internet access equipment may include: If the dial-up command has already been delivered to the wireless Internet access equipment before step 17, the wireless Internet access equipment establishes a data service connection with the wireless network according to the dial-up command and the dial-up connection settings. Alternatively, if the dial-up command has not been delivered to the wireless Internet access equipment before step 17, the wireless Internet access equipment first receives the dial-up command delivered by the PC, and then establishes a data service connection with the wireless network according to the dial-up command and the dial-up connection settings.

In other embodiments, it can be configured that different fingerprint information corresponds to different dial-up connection settings, that is, different fingerprint templates are bound to different dial-up connection settings respectively. Therefore, in step 15, if the fingerprint information input by the user matches with one of the multiple stored fingerprint templates, in step 17, the wireless Internet access equipment performs a dial-up connection and establishes a data service connection with the wireless network according to the dial-up connection settings corresponding to the matched fingerprint template. Thus, the fingerprint information of different fingers of the user can be bound to different dial-up connection settings, such as Access Point Name (APN) and authentication parameters. After the fingerprint authentication is performed and the fingerprint information is matched with the fingerprint template, corresponding dial-up connection settings can be found and a connection is initiated automatically in step 17. By setting multiple fingerprint templates to bind different dial-up connection settings to the different fingerprint templates, various fingerprint dial-up modes can be provided for the same wireless Internet access equipment. Thus, the variety of the fingerprint authentication is improved and the flexibility of the dial-up of the wireless Internet access equipment is also improved.

It should be noted that, when the fingerprint authentication is used for the first time, it may be necessary to prompt the user to record a fingerprint template. The user inputs fingerprint information by using a fingerprint sensor, and the wireless Internet access equipment stores the fingerprint information collected by the fingerprint sensor as a fingerprint template, thus accomplishing the recording of the fingerprint template. In addition, for the wireless Internet access equipment, the above dial-up method of the wireless Internet access equipment may be set so as to turn on or off the dial-up function of the wireless Internet access equipment, where the dial-up function of the wireless Internet access equipment is implemented by the fingerprint authentication. Therefore, the recording of the fingerprint template can also be performed when the dial-up function of the wireless Internet access equipment is turned on, where the dial-up function of the wireless Internet access equipment is implemented by the fingerprint authentication.

In this embodiment, specifically, the wireless Internet access equipment may be various modem equipment or modules that can connect the PC to the Internet via the wireless network such as a data card, a wireless broadband module, a mobile phone, and a mobile Internet access terminal.

In this embodiment, the fingerprint information input by the user is obtained by using the fingerprint sensor, and the input fingerprint information is matched with the stored fingerprint template. When the matching is successful, a data service connection between the wireless Internet access equipment and the wireless network is established. Therefore, the dial-up function of the wireless Internet access equipment is protected by using the fingerprint authentication, so that it becomes very difficult to misappropriate the wireless Internet access equipment, and the security of the dial-up of the wireless Internet access equipment is improved. Moreover, as the wireless Internet access equipment automatically performs a dial-up connection when the fingerprint authentication is successful, the present invention provides a brand-new dial-up method of a wireless Internet access equipment, which can reduce the complexity of the dial-up connection and provide the availability and automation of the dial-up connection.

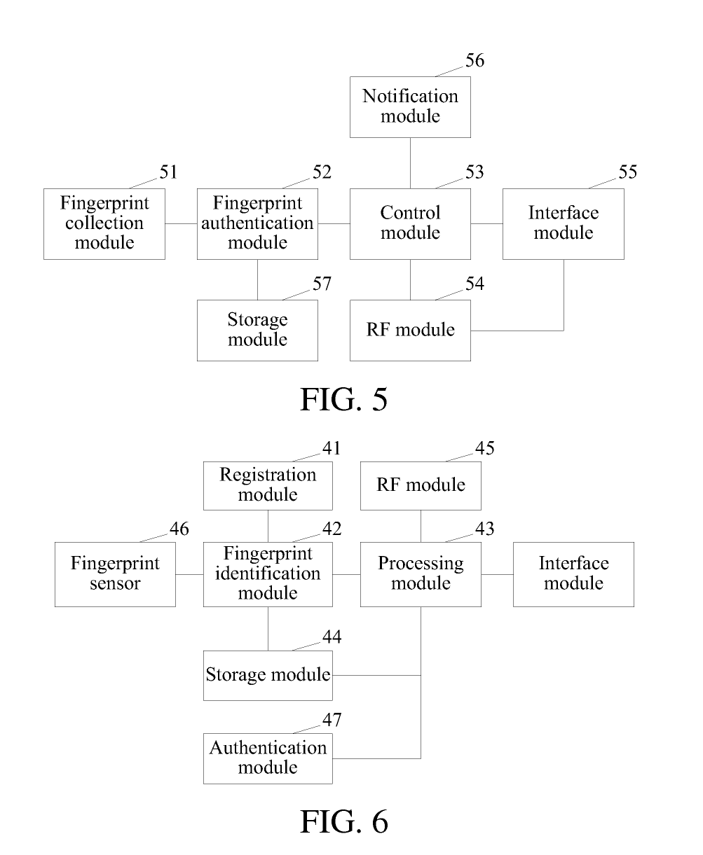

As shown in FIG. 5, an embodiment of the present invention provides a fingerprint identification data card, which includes a number of modules. A fingerprint collection module 51 is configured to collect user's fingerprint information by using a fingerprint scanner of the data card. A fingerprint authentication module 52 is configured to compare the collected fingerprint information with the stored fingerprint template to determine whether the collected fingerprint information matches with the fingerprint template, and to output a comparison result. A control module 53 is configured to perform corresponding control on the data card according to the comparison result output by the fingerprint authentication module 52. A radio frequency module 54 is configured to establish a wireless connection with the Internet to receive and transmit data.

The corresponding control on the data card may be described as follows. The user is authenticated through the fingerprint authentication. If the collected fingerprint information matches with the fingerprint template, it is determined that the authentication is successful, and the user corresponding to the collected fingerprint information is allowed to access the Internet by using the data card. Otherwise, if the collected fingerprint information does not match with the fingerprint template, it is determined that the authentication is failed, and the user is not allowed to use the data card. In addition, or alternatively, one or more different fingerprint templates are stored, and each fingerprint template corresponds to a different operation. If the collected fingerprint information matched with any one of the fingerprint templates, the operation corresponding to the matched fingerprint template is performed. If the collected fingerprint information matches with none of the fingerprint templates, the data card may perform no operation or notify the user that the fingerprint authentication is failed through the data card or the user terminal connected to the data card.

For an implementation manner that the user corresponding to the collected fingerprint information is allowed to access the Internet by using the data card, for example, may be: The control module 53 may not execute the user's instructions (such as an instruction of connecting the Internet by using the RF module 54, or an instruction of reading data stored in the data card and so on) before the authentication is successful. After the authentication is successful, the control module 53 enters a normal work state, and receives and executes the user's instructions, so that the user can access the Internet by using the data card, or read and write the data stored in the data card.

Similarly, a case the user is not allowed to use the data card can be as follows. The control module 53 does not execute the user's instructions, and thus does not accept the user's control over each module and function of the data card. Since the user is not allowed to use the data card if the collected fingerprint information does not match with the fingerprint template. The authentication of the data card is achieved through the fingerprint authentication. The user is only allowed to use the data card after the fingerprint is successfully matched, so that the right of using the data card is effectively controlled.

For an implementation manner of an operation corresponding to the matched fingerprint templates, for example, may be described as follows. If the data card includes two or more RF modules 54, each RF module 54 corresponds to one or more fingerprint templates, and different RF modules 54 correspond to different fingerprint templates. According to the comparison result output by the fingerprint authentication module 52, the control module 53 is configured to perform corresponding control on the data card. If the collected fingerprint information matches with one of the fingerprint templates, the radio frequency module 54 corresponding to the fingerprint template is initiated, so that the data card establishes a connection with the network by using the RF module 54 corresponding to the fingerprint template.

If the collected fingerprint information matches with none of the fingerprint templates, the user is notified, through the data card or a user terminal connected to the data card, that the fingerprint authentication is failed. Alternatively, if the data card includes one or more RF modules 54, each RF module 54 corresponds to one or more turn on fingerprint templates and corresponds to one or more turnoff fingerprint templates, and different RF modules 54 correspond to different fingerprint templates.

The RF module 54 corresponding to the turn on fingerprint template is turned on if the collected fingerprint information matches with one of the turn on fingerprint templates, so that the data card establishes a connection with the network through the RF module 54 corresponding to the turn on fingerprint template. The RF module 54 corresponding to the turnoff fingerprint template is turned off if the collected fingerprint information matches with one of the turnoff fingerprint templates, so that the connection between the data card and the network through the RF module 54 corresponding to the turnoff fingerprint template is disconnected (if the RF module 54 corresponding to the turnoff fingerprint template does not establish a connection with the network, that is, the RF module 54 corresponding to the turnoff fingerprint template is in an “off” state, no operation is performed or the user is notified that the RF module 54 corresponding to the turnoff fingerprint template has already been turned off if the collected fingerprint information matches with the turnoff fingerprint template).

If the collected fingerprint information matches with none of the turn on fingerprint templates or the turnoff fingerprint templates, the user is notified that the fingerprint authentication is failed through the data card or the user terminal connected to the data card. When the turnoff fingerprint templates are set and the user does not need to use the network, for example only a function of a Secure Digital Memory Card (SD card) of the wireless data card is used, the user can choose to turn off the RF module 54 by fingerprinting, so as to avoid radiation and power consumption.

For example, the user registers the left little finger as a turnoff fingerprint template to turn off the RF module 54. When the user swipes the left little finger, the control module 53 will turn off the RF module 54, which will be turned on only when the user swipes the finger of relative functions. Since the RF module 54 is turned on after the fingerprint authentication is successful, the user can access the wireless network only after the fingerprint authentication is successful, so that the user's right for accessing the Internet by using the data card is effectively controlled.

It should be noted that, if the data card is a multi-mode data card, the multi-mode data card may include two or more RF modules, for example, any two or more of a GSM RF module, a WCDMA RF module, a CDMA RF module, a CDMA7000 RF module, and a Time Division-Synchronous Code Division Multiple Access (TD-SCDMA) RF module. For a multi-mode data card, the user may choose different network services by registering different fingerprint templates. For example, for a data card that supports both the GSM and the WCDMA, the user registers the left index finger to initiate the GSM network and registers the right index finger to initiate the WCDMA network. After inserting the data card, the user swipes the left index finger to initiate the RF module of the GSM, and at this time, the user can search and register with the GSM network. Similarly, the user swipes the right index finger to initiate the RF module of the WCDMA to use the WCDMA network.

The above data card further includes an interface module 55, configured to connect the data card to the user terminal through various interfaces (such as a USB interface), so that the user terminal can perform data transmission with the network by using the data card. The interface module 55 here may be a cable interface (such as a USB interface) or a wireless interface (such as a Bluetooth interface).

In addition, the above data card may further include a notification module 56, configured to notify, through the data card or the user terminal connected to the data card, the user of the fingerprint authentication result.

In addition, the above data card may further include a storage module 57, configured to store the above fingerprint templates (including turn on fingerprint templates and/or turnoff fingerprint templates). The storage module 57 may be a memory or a non-volatile memory such as a Flash. The fingerprint templates stored in the storage module 57 may be input through the fingerprint collection module 51 and stored in the storage module 57 when the data card is set. For example, when the user initiates the data card for the first time, the data card prompts the user to input respective fingerprint templates, and at this time stores the fingerprint information input by using the fingerprint collection module 51 in the storage module 57 as fingerprint templates. Alternatively, during the use of the data card, the original fingerprint template is updated and replaced, and at this time the fingerprint information input by using the fingerprint collection module 51 is stored in the storage module 57 to replace the original fingerprint template. Before the update and replacement, it can be set that the update and replacement are only allowed when the user inputs the correct fingerprint information and the fingerprint authentication is successful.

It should be noted that, if the data card only has one RF module 54, when the data card is powered on, the RF module 54 immediately starts to search and register with the network, and the control module 53 does not allow the user to use the data card. Next, after the fingerprint authentication is successful (that is, the collected fingerprint information matches with the fingerprint template), the control module 53 allows the user to use the data card to perform data transmission through the wireless network connected by using the RF module 54. Alternatively, when the data card is powered on, the control module 53 does not allow the user to use the data card and the RF module is in an “off” state. Next, after the fingerprint authentication is successful, the RF module 54 starts to search and register with the network and the control module 53 allows the user to use the data card. In the end, the user can perform data transmission through the wireless network connected by using the RF module 54.

In this embodiment, the user's fingerprint information is collected by using the fingerprint scanner on the data card and compared with the stored fingerprint template, and then the data card is controlled according to the comparison result output by the fingerprint authentication module. Therefore, the right control of the data card is achieved through fingerprint authentication, and related functions of the data card can only be used after successful fingerprint matching. Since the security of fingerprint authentication is much higher than the security of password authentication, the security of the data card is improved, and it is effectively ensured that the data card is not misappropriated. In addition, the fingerprint authentication is performed for the data card, so even if the user changes an SIM card, the data card still cannot be used as long as the fingerprint authentication is failed, so that the security of the data card is further improved. Moreover, during fingerprint authentication the user does not need to remember a password and the network connection is automatically established upon successful fingerprint authentication. Therefore, it becomes more convenient for the user, and the complexity of the operations is reduced.

As shown in FIG. 6, another embodiment of the present invention provides a wireless Internet access equipment, which includes a number of modules. A registration module 41 is configured to register the wireless Internet access equipment with a wireless network. A fingerprint identification module 42 is configured to obtain fingerprint information input by a user by using a fingerprint sensor and to match the input fingerprint information with a stored fingerprint template after the registration module 41 finishes registration. A processing module 43 is configured to perform a dial-up connection and to establish a data service connection between the wireless Internet access equipment and the wireless network when the input fingerprint information matches with the stored fingerprint template in the fingerprint identification module 42.

Optionally, the wireless Internet access equipment may further include a storage module 44, which is configured to store the fingerprint templates for modules such as the fingerprint identification module 42 and/or the processing module 43 to read and write. The storage module may be a memory or a non-volatile memory such as a Synchronous Dynamic Random Access Memory (SDRAM) or a flash chip.

Optionally, the wireless Internet access equipment may further include an RF module 45, which is configured to send and receive wireless signals and to bear a dial-up connection between the wireless Internet access equipment and the wireless network.

Optionally, the wireless Internet access equipment may further include a fingerprint sensor 46, which is configured to obtain fingerprint information input by the user, and send the obtained fingerprint information to the fingerprint identification module 42. In other embodiments, the fingerprint sensor 46 may also not be integrated in the wireless Internet access equipment. For example, the fingerprint sensor 46 may be disposed in a PC or other equipment (such as a separated USB fingerprint sensor) and connected to the PC through various interfaces.

Optionally, the wireless Internet access equipment may further include an authentication module 47, configured to perform PIN code authentication after the wireless Internet access equipment is powered on.

When the fingerprint authentication is used for the first time, or a dial-up function of the wireless Internet access equipment is turned on, where the dial-up function of the wireless Internet access equipment is implemented by the fingerprint authentication, the user needs to be prompted to input a fingerprint template. At this time, the fingerprint identification module 42 may be further configured to store the fingerprint information input by the user in the storage module 44 as a fingerprint template.

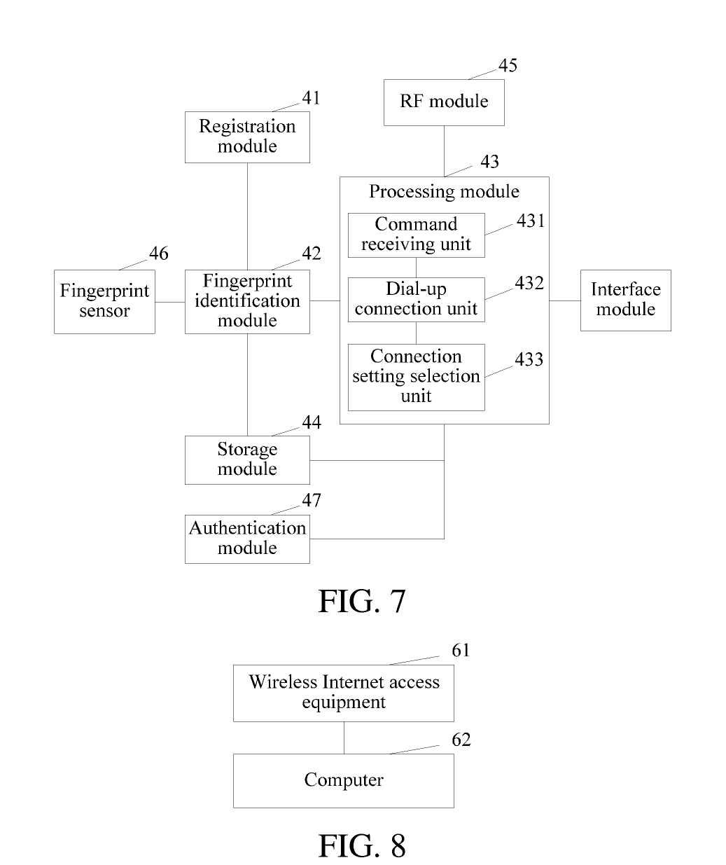

Referring to FIG. 7, the processing module 43 may further include a command receiving unit 431 and a dial-up connection unit 432. The command receiving unit 431 is configured to receive a dial-up command delivered by the PC. The dial-up connection unit 432 is configured to establish a data service connection between the wireless Internet access equipment and the wireless network according to the dial-up command and dial-up connection settings received by the command receiving unit 431. In addition, the occasion that the PC delivers the dial-up command may be referred to the related contents in the method embodiment, which will not be described here. Furthermore, the processing module 43 may further include a connection setting selection unit 433, configured to read the dial-up connection settings bound to the matched fingerprint templates in the storage module 44 when binding different fingerprint templates to different dial-up connection settings respectively, so that the dial-up connection unit 432 establishes a data service connection between the wireless Internet access equipment and the wireless network according to the dial-up command and the dial-up connection settings bound to the matched fingerprint template.

In this embodiment, specifically, the wireless Internet access equipment may be various modem equipment or modules which can connect the PC to the Internet via the wireless network such as a data card, a wireless broadband module, a mobile phone, and a mobile Internet access terminal.

In this embodiment, the fingerprint information input by the user is obtained by the fingerprint sensor, and the input fingerprint information is matched with the stored fingerprint template. When the matching is successful, a data service connection between the wireless Internet access equipment and the wireless network is established. Therefore, the dial-up function of the wireless Internet access equipment is protected by using the fingerprint authentication, so that it becomes very difficult to misappropriate the wireless Internet access equipment, and the security of the dial-up of the wireless Internet access equipment is improved. Moreover, since the wireless Internet access equipment automatically performs the dial-up connection without the user's intervention when the fingerprint authentication is successful, an embodiment of the present invention provides a brand-new dial-up method of the wireless Internet access equipment, so as to reduce the complexity of the dial-up connection and provide the availability and automation of the dial-up connection.

As shown in FIG. 8, another embodiment of the present invention provides a wireless Internet access system, which includes wireless Internet access equipment 61 and a computer 62.

The wireless Internet access equipment 61 is configured to be registered with a wireless network. Fingerprint information input by a user is obtained by using a fingerprint sensor and matched with the stored fingerprint template. When the input fingerprint information matches with the stored fingerprint template, a dial-up connection is performed and a data service connection between the wireless Internet access equipment 61 and the wireless network is established.

The computer 62 is configured to control the wireless Internet access equipment 61 to perform a dial-up connection, and perform data services by using the data service connection between the wireless Internet access equipment 61 and the wireless network.

The wireless Internet access equipment 61 and the computer 62 can be connected through various interfaces such as the USB, the Express Card, the Personal Computer Memory Card International Association (PCMCIA), or the Peripheral Controller Interface (PCI), and transmission of data and commands is performed.

The specific structure and operations of the wireless Internet access equipment 61 can be referred to the related contents in the device embodiment and the method embodiment, which will not be described here.

In this embodiment, the fingerprint information input by the user is obtained by using the fingerprint sensor and matched with the stored fingerprint template. When the matching is successful, a data service connection between the wireless Internet access equipment and the wireless network is established. Therefore, the dial-up function of the wireless Internet access equipment is protected by using the fingerprint authentication, so that it becomes very difficult to misappropriate the wireless Internet access equipment, and the security of the dial-up of the wireless Internet access equipment is improved. Moreover, since the wireless Internet access equipment automatically performs a dial-up connection without the user's intervention when the fingerprint authentication is successful, the present invention provides a brand-new dial-up method of the wireless Internet access equipment, which can reduce the complexity of the dial-up connection and provide the availability and automation of the dial-up connection.

Persons of ordinary skill in the art should understand that all or a part of the steps of the method according to the embodiments of the present invention may be implemented by a computer program instructing relevant hardware. The program may be stored in a computer readable storage medium. When the program is run, the steps of the method according to the embodiments of the present invention are performed. The storage medium may be a magnetic disk, an optical disk, a read-only memory (ROM), and a random access memory (RAM).

The above descriptions are merely preferred embodiments of the present invention, but not intended to limit the scope of the present invention. Any modification, equivalent replacement, or improvement made without departing from the spirit and principle of the present invention should fall within the scope of the present invention.

What is claimed is:

1. A data card, comprising:
a fingerprint collection module, configured to collect user's fingerprint information by using a fingerprint scanner operably connected to the data card;
a fingerprint authentication module, configured to compare the collected fingerprint information with a stored fingerprint template and to output a comparison result; and
a control module, configured to control the data card according to the comparison result output by the fingerprint authentication module.

2. The data card according to claim 1, further comprising:
a radio frequency (RF) module that is configured to establish a wireless connection between the data card and a network to receive and transmit data;
wherein the control module is configured to control the data card by allowing the data card to be used to access the network to receive and transmit data if the collected fingerprint information matches with the fingerprint template.

3. The data card according to claim 1, wherein the control module is configured to control the data card by performing an operation corresponding to the fingerprint template, if the collected fingerprint information matches with the fingerprint template.

4. The data card according to claim 3, further comprising:
at least one RF module, configured to establish a wireless connection between the data card and a network to receive and transmit data;
wherein, if the collected fingerprint information matches with one fingerprint template, the RF module corresponding to the fingerprint template is turned on so that the data card establishes a connection with the network through the RF module corresponding to the fingerprint template; or, if the collected fingerprint information matches with a turnon fingerprint template, the RF module corresponding to the turnon fingerprint template is turned on so that the data card establishes a connection with the network through the RF module corresponding to the turnon fingerprint template; if the collected fingerprint information matches with a turnoff fingerprint template, the RF module corresponding to the turnoff fingerprint template is turned off and a connection between the data card and the network through the RF module corresponding to the turnoff fingerprint template is disconnected.

5. The data card according to claim 1, further comprising an interface module, configured to connect the data card to a user terminal through a plurality of interfaces, so that the user terminal can perform data transmission with the network by using the data card.

6. The data card according to claim 1, further comprising a notification module, configured to notify, through the data card itself or a user terminal connected to the data card, the user of a fingerprint authentication result.

7. The data card according to claim 1, wherein the data card further comprises a storage module, configured to store the fingerprint template.

8. The data card according to claim 1, wherein the control module is configured to control the data card by registering the data card with the wireless network and establishing a connection with the wireless network when the comparison result is that the collected fingerprint information matches with the stored fingerprint template.

9. A wireless Internet access equipment, comprising:
a registration module, configured to register the wireless Internet access equipment with a wireless network;
a fingerprint identification module, configured to obtain fingerprint information input by a user by using a fingerprint sensor and to match the input fingerprint information with a stored fingerprint template after the registration module finishes registration; and
a processing module, configured to establish a data service connection between the wireless Internet access equipment and the wireless network when the fingerprint identification module successfully matches the input fingerprint information with the stored fingerprint template.

10. The equipment according to claim 9, further comprising a fingerprint sensor, configured to obtain the fingerprint information input by the user, and to send the obtained fingerprint information to the fingerprint identification module.

11. The equipment according to claim 9, wherein the fingerprint identification module is further configured to store the fingerprint information input by the user as a fingerprint template for the first time.

12. The equipment according to claim 9, wherein the processing module further comprises:
a command receiving unit, configured to receive a dial-up command delivered by a computer; and
a dial-up connection unit, configured to establish a data service connection between the wireless Internet access equipment and the wireless network according to the dial-up command received by the command receiving unit and dial-up connection settings.

13. The equipment according to claim 12, wherein the processing module further comprises:
a connection setting selection unit, configured to read a dial-up connection setting corresponding to a fingerprint template that matches with the input fingerprint information when multiple stored fingerprint templates are stored and each fingerprint template binds respective dial-up connection settings, so that the dial-up connection unit establishes a data service connection between the wireless Internet access equipment and the wireless network according to the dial-up command and the dial-up connection setting corresponding to the fingerprint template.

14. The equipment according to claim 9, wherein the wireless Internet access equipment comprises a data card, a wireless broadband module, a mobile phone or a mobile Internet access terminal.

15. A method for identifying a fingerprint associated with a data card, the method comprising:
collecting user fingerprint information by using a fingerprint scanner operably connected to the data card;
comparing the collected fingerprint information with a stored fingerprint template to determine a comparison result; and
controlling the data card according to the comparison result.

16. The method according to claim 15, wherein controlling the data card comprises:
if the collected fingerprint information matches with the fingerprint template, allowing the data card to be used to access the Internet to receive and transmit data.

17. The method according to claim 15, wherein the stored fingerprint template comprises one of a plurality of stored fingerprint templates, and wherein controlling the data card comprises, if the collected fingerprint information matches with one of the fingerprint templates, performing an operation corresponding to one of the fingerprint templates, and if the collected fingerprint information matches with none of the fingerprint templates, performing, by the data card, no operation or notifying a user that the fingerprint authentication has failed.

18. The method according to claim 17, wherein performing the operation corresponding to the fingerprint template comprises:
if the collected fingerprint information matches with the one of the fingerprint templates, turning on a radio frequency (RF) module corresponding to the one of the fingerprint templates, so that the data card establishes a connection with a network through the RF module corresponding to the fingerprint template.

19. The method according to claim 17, wherein performing the operation corresponding to the fingerprint template comprises:
if the collected fingerprint information matches with a turnon fingerprint template, turning on an RF module corresponding to the turnon fingerprint template, so that the data card establishes a connection with the network through the RF module corresponding to the turnon fingerprint template; and if the collected fingerprint information matches with a turnoff fingerprint template, turning off an RF module corresponding to the turnoff fingerprint template, and disconnecting a connection between the data card and the network through the RF module corresponding to the turnoff fingerprint template.

20. The method according to claim 15, wherein the method further comprises sending a notification to the user through the data card itself or through a user terminal connected to the data card to notify the user of a fingerprint authentication result.

21. The method according to claim 15, wherein the method further comprises when the data card is set, collecting a fingerprint template through the fingerprint scanner, and storing the fingerprint template in a storage module of the data card.

22. The method according to claim 15, wherein controlling the data card comprises:
registering the data card with the wireless network and establishing a connection with the wireless network when the comparison result is that the collected fingerprint information matches with the stored fingerprint template.

23. A dial-up method for accessing wireless Internet, the method comprising:
registering a wireless Internet access equipment with a wireless network;
obtaining fingerprint information input by a user by using a fingerprint scanner of a data card;
matching the input fingerprint information with a stored fingerprint template; and
if the input fingerprint information successfully matches with the stored fingerprint template, performing, by the wireless Internet access equipment, a dial-up connection, and establishing a data service connection with the wireless network.

24. The method according to claim 23, wherein matching the input fingerprint information with the stored fingerprint template comprises:
receiving, by the wireless Internet access equipment, the fingerprint information sent by the fingerprint sensor; and
matching the received fingerprint information with the fingerprint template stored by the wireless Internet access equipment;
wherein the fingerprint sensor is integrated in the wireless Internet access equipment.

25. The method according to claim 23, wherein, when the fingerprint authentication is used for the first time, the method further comprises:
prompting the user to record a fingerprint template; and
storing the fingerprint information collected by the fingerprint sensor as a fingerprint template to record the fingerprint template.

26. The method according to claim 23, wherein after registering the wireless Internet access equipment with the wireless network, or after obtaining the fingerprint information input by the user by using the fingerprint sensor, or when the input fingerprint information successfully matches with the stored fingerprint template, the method further comprises:
receiving, by the wireless Internet access equipment, a dial-up command delivered by a computer; and
wherein performing the dial-up connection and establishing the data service connection comprises establishing, by the wireless Internet access equipment, a data service connection with the wireless network according to the delivered dial-up command and dial-up connection settings.

27. The method according to claim 26, wherein when multiple fingerprint templates are stored, and each fingerprint template binds respective dial-up connection settings, the method further comprises:
reading a dial-up connection setting corresponding to a fingerprint template that matches with the input fingerprint information, wherein the corresponding dial-up connection setting is used for dial-up connection by the wireless Internet access equipment, so as to establish a data service connection with the wireless network.
